(19) United States
(12) Patent Application Publication
(10) Pub. No.: US 2016/0225230 A1
(43) Pub. Date: Aug. 4, 2016

(54) LOTTERY WINNINGS NOTIFICATION SYSTEM

(71) Applicant: Excalibur One Investment Group, Lithonia, GA (US)

(72) Inventor: Robford Elton Hill, Decatur, GA (US)

(21) Appl. No.: 15/010,838

(22) Filed: Jan. 29, 2016

Related U.S. Application Data
(60) Provisional application No. 62/110,276, filed on Jan. 30, 2015.

(51) Int. Cl. G07F 17/32

(52) U.S. Cl. CPC G07F 17/3255; G07F 17/329; G07F 17/323

(57) ABSTRACT

Embodiments of the invention are directed to systems, methods and computer program products to receive one or more lottery tickets from the customer associated with the identification device; retrieve and store information associated with the one or more received lottery tickets; determine that at least one of the one or more received lottery tickets is a winning lottery ticket based on at least the retrieved information; and notify the customer of the winning lottery ticket using information associated with the customer's notification account.

### CLAIM OF PRIORITY UNDER 35 U.S.C. §119

This Non-Provisional Patent Application claims priority to U.S. Provisional Patent Application No. 62/110,276 entitled “Lottery Winnings Notification System” (filed Jan. 30, 2015), which is hereby expressly incorporated by reference in its entirety.

### BACKGROUND

A lottery is any scheme for distribution of prizes to one or more individuals determined by chance. Lotteries come in many formats. Lottery tickets are typically paper tickets with a predetermined set of numbers often made of thin paper-based cards. When a lottery ticket winner is determined, the individual in possession of the winning lottery ticket is expected to produce the winning lottery ticket to claim the prize. Unfortunately, a large number of lottery ticket winnings remain unclaimed due a number of reasons, the most common of reasons being that (1) the individual in possession of the lottery ticket is unaware of the lottery winnings or (2) a lottery ticket is misplaced. Therefore, a need exists for a system to notify individuals of lottery winnings.

### BRIEF SUMMARY

Embodiments of the invention are directed to systems, methods, and computer program products for notifying lottery winnings to a customer.

In one embodiment of the invention, a system for notifying a customer of a winning lottery ticket is presented. The system comprising: at least one non-transitory storage device; at least one computing processor; and at least one module stored in said storage device and comprising instruction code executable by the at least one computing processor, and configured to cause the at least one computing processor to: receive one or more lottery tickets from the customer; retrieve and store information associated with the one or more received lottery tickets; determine that at least one of the one or more received lottery tickets is a winning lottery ticket based on at least the retrieved information; and notify the customer of the winning lottery ticket.

In another embodiment, a system for notifying a customer of a winning lottery ticket is presented. The system comprising: at least one lottery ticket reading device, the device comprising: at least one non-transitory storage device; at least one computing processor; and at least one reading module stored in the storage device and comprising instruction code executable by the at least one computing processor, and configured to cause the at least one computing processor to: receive one or more lottery tickets from the customer; retrieve information associated with the one or more received lottery tickets; and store the retrieved information in a database associated with the customer. In some embodiments, the system comprises at least one notification device, the device comprising: at least one non-transitory storage device; at least one computing processor; and at least one notification module stored in the storage device and comprising instruction code executable by the at least one computing processor, and configured to cause the at least one computing processor to: determine that at least one of the one or more received lottery tickets is a winning lottery ticket based on at least the retrieved information; and notify the customer of the winning lottery ticket.

In some embodiments or in combination with any of the previous embodiments, the instruction code of the at least one notification module is further configured for causing the at least one processor to: receive information associated with a winning lottery ticket from one or more external sources; compare the information associated with the winning lottery ticket with the information associated with the one or more lottery tickets received from the customer to determine a match; determine that at least one of the one or more lottery tickets received from the customer is the winning lottery ticket; retrieve customer information from the database, wherein the customer information comprises a mobile phone number; and transmit a notification to the customer indicating that the customer has purchased a winning lottery ticket.

In some embodiments or in combination with any of the previous embodiments, the instruction code of the at least one notification module is further configured for causing the at least one processor to transmit a notification to the user by at least one of a text message, multimedia message, social network message, email, or telephone call to the customer based on at least the customer information.

In another embodiment of the invention, a system for receiving one or more lottery tickets from a customer is presented. The system comprising: at least one lottery ticket reading device, the device comprising: at least one non-transitory storage device; at least one computing processor; and at least one lottery ticket reading module stored in the storage device and comprising instruction code executable by the at least one computing processor, and configured to cause the at least one computing processor to: receive one or more lottery tickets from the customer; retrieve information associated with the one or more lottery tickets; and transmit the information associated with the one or more lottery tickets to a base station device/module; and the at least one base station device, the device comprising: at least one non-transitory storage device; at least one computing processor; and at least one receiver module stored in said storage device and comprising instruction code executable by the at least one computing processor, and configured to cause the at least one computing processor to: receive information associated with one or more lottery tickets from the at least one lottery ticket reading module; and transmit the information associated with the one or more lottery tickets received from the at least one lottery ticket module to be stored in a database.

In some embodiments or in combination with any of the previous embodiments, the instruction code of the at least one base station module is further configured for causing the at least one processor to: provide a notification account for a customer, the notification account comprising an unique account number; associate the account number with an identification device such that, in response to associating the account number with the identification device, the account is linked to the identification device; receive funds from a customer, the funds being equivalent to a monetary amount; and load the monetary amount into the notification account.

In some embodiments or in combination with any of the previous embodiments, the instruction code of the at least one base station module is further configured for causing the at least one processor to: determine that the customer's notification account balance is lesser than a monetary value associated with the one or more lottery tickets received from the customer; notify, using a display of the at least one lottery ticket reading device, that the customer does not have sufficient balance to process the one or more lottery tickets, wherein notifying further comprises temporarily pausing the processing of the one or more received lottery tickets; initiate the presentation of one or more payment options to the customer to enable the customer load additional funds to continue processing the one or more lottery tickets; receive a customer input to load additional funds using the one or more payment options; and in response to loading the additional funds, continue processing the one or more lottery tickets based on at least determining that the remaining balance in the customer's notification account after the additional funds are loaded by the customer is greater than or equal to the monetary value associated with the one or more lottery tickets received from the customer.

In some embodiments or in combination with any of the previous embodiments, the instruction code of the at least one base station module is further configured for causing the at least one processor to: initiate presentation of an identification device interface to a customer, wherein the identification device interface comprises one or more text fields to receive customer information; receive a customer input, the customer input comprising information associated with the customer; and provide a notification account for the customer based on at least the received customer information.

In some embodiments or in combination with any of the previous embodiments, the instruction code of the at least one base station module is further configured for causing the at least one processor to: receive a request from the customer to access the lottery ticket reading module, the request comprises receiving an identification device associated with the customer; retrieve one or more authentication credentials associated with the customer from the identification device; validate the one or more authentication credentials; and authenticate the customer's identity based on at least validating the one or more authentication credentials.

In some embodiments or in combination with any of the previous embodiments, the instruction code of the at least one base station module is further configured for causing the at least one processor to: capture and image of the one or more lottery tickets received from the customer; and retrieve information associated with the one or more lottery tickets from the captured image by using optical character recognition (OCR), wherein the information comprises at least a lottery game type, submission date, lottery game date, lottery options played by the customer, lottery drawing date, and a lottery ticket type.

In some embodiments or in combination with any of the previous embodiments, the instruction code of the at least one base station module is further configured for causing the at least one processor to: present, in response to authenticating the customer's identity, an account balance associated with the customer's notification account on a display of the at least one lottery ticket reading device; receive the one or more lottery tickets from the customer; debit from the customer's account balance, a monetary value associated with each of the one or more lottery tickets; and present, in response to debiting, an updated account balance on the display.

In some embodiments or in combination with any of the previous embodiments, the instruction code of the at least one base station module is further configured for causing the at least one processor to: determine, using a sensor device, that the customer is located in proximity to the module prior to receiving an identification device from the customer for authentication.

In some embodiments or in combination with any of the previous embodiments, the instruction code of the at least one base station module is further configured for causing the at least one processor to: present, on a display of the at least one lottery ticket reading device, instructions for receiving the one or more lottery tickets after authenticating the customer's identity.

In some embodiments or in combination with any of the previous embodiments, the instruction code of the at least one base station module is further configured for causing the at least one processor to: present, on a display of the at least one lottery ticket reading device, a message indicating the one or more lottery tickets were successfully received and/or processed.

In some embodiments or in combination with any of the previous embodiments, the instruction code of the at least one base station module is further configured for causing the at least one processor to: present, on a display of the at least one lottery ticket reading device, an advertisement provided by at least one of a merchant where the system is located or an entity responsible for maintaining the system/apparatus.

In one embodiment of the invention, a computer implemented method for notifying a customer of a winning lottery ticket is presented. The method comprising: receiving, using a computing device processor, one or more lottery tickets from the customer at one or more lottery ticket reading devices; retrieving, using a computing device processor, information associated with the one or more lottery tickets from each of the one or more lottery ticket reading devices; determining, using a computing device processor, that at least one of the one or more received lottery tickets is a winning lottery ticket based on at least the retrieved information; and notifying, using a computing device processor, the customer of the winning lottery ticket.

In some embodiments or in combination with any of the previous embodiments, the computer implemented further comprises: transmitting, using a computing device processor, the information associated with the one or more lottery tickets from each of the one or more lottery ticket reading devices to a base station device; and transmitting, using a computing device processor associated with the base station device, the information associated with the one or more lottery tickets received from the one or more lottery ticket reading devices to a database for storage.

In some embodiments or in combination with any of the previous embodiments, the computer implemented further comprises: receiving, using a computing device processor, information associated with a winning lottery ticket from one or more external sources; comparing, using a computing device processor, the information associated with the winning lottery ticket with the information associated with the one or more lottery tickets received from the customer to determine a match; determining, using a computing device processor, that at least one of the one or more lottery tickets received from the customer is the winning lottery ticket; retrieving, using a computing device processor, customer information from a database, wherein the customer information comprises a mobile phone number; and transmitting, using a computing device processor, a notification to the customer indicating that the customer has purchased a winning lottery ticket.

In yet another embodiment of the invention, a computer program product for notifying a customer of a winning lottery ticket is presented. The computer program product comprising a non-transitory computer-readable medium comprising code causing a first apparatus to: receive one or more lottery tickets from the customer at one or more lottery ticket reading devices; retrieve information associated with the one or more lottery tickets from each of the one or more lottery ticket reading devices; determine that at least one of the one or more received lottery tickets is a winning lottery ticket based on at least the retrieved information; and notify the customer of the winning lottery ticket.

In some embodiments or in combination with any of the previous embodiments, the non-transitory computer-readable medium comprises code further causes the first apparatus to: transmit the information associated with the one or more lottery tickets from each of the one or more lottery ticket reading devices to a base station device; receive information associated with a winning lottery ticket from one or more external sources; compare the information associated with the winning lottery ticket with the information associated with the one or more lottery tickets received from the customer to determine a match; determine that at least one of the one or more lottery tickets received from the customer is the winning lottery ticket; retrieve customer information from the database, wherein the customer information comprises a mobile phone number; and transmit a notification to the customer indicating that the customer has purchased a winning lottery ticket.

### BRIEF DESCRIPTION OF THE DRAWINGS

Having thus described embodiments of the invention in general terms, reference will now be made to the accompanying drawings, where:

FIG. 1A illustrates a system environment for a lottery winnings notification system in accordance with an embodiment of the present invention;

FIG. 1B illustrates a high level process flow for a lottery winnings notification system in accordance with an embodiment of the present invention;

FIG. 2A illustrates an exemplary lottery ticket reading device in accordance with an embodiment of the invention;

FIG. 2B illustrates a process flow for retrieving information from one or more lottery tickets in accordance with an embodiment of the invention;

FIG. 3A illustrates an exemplary base station device in accordance with an embodiment of the invention;

FIG. 3B illustrates a high level process flow for issuing an identification device to a customer in accordance with an embodiment of the invention;

FIG. 4A illustrates an exemplary lottery server in accordance with an embodiment of the invention; and

FIG. 4B illustrates a high level process flow for notifying a customer of the winning lottery ticket in accordance with an embodiment of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products configured for transforming lottery information associated with a physical lottery ticket into formatted data, automatically ascertaining the status of the lottery ticket, and dynamically notifying a customer of a winning lottery ticket. Embodiments enhance a customer's lottery experience at a merchant location by reading a lottery ticket presented by the customer at a lottery ticket reading device. The lottery ticket reading device is configured for at least authenticating a user, receiving physical lottery tickets, initiating purchase of the lottery tickets, capturing electronic images of the physical lottery tickets, retrieving information from the lottery tickets, and/or transforming the retrieved information into searchable and retrievable formatted data to be stored in a database. In some embodiments, the lottery ticket reading device is configured to establish an operative communication channel with a customer identification device to perform one or more steps described herein. Embodiments of the invention use customer information received from the customer and/or retrieved from a customer profile to associate the customer's information with the information retrieved from the lottery ticket. When a winning lottery ticket is announced, the embodiments of the invention compare the information associated with the winning lottery ticket with the lottery ticket purchased by the customer to determine whether a match exists, in real-time or near real-time. If a match is determined, embodiments of the invention notify the customer of the winning lottery ticket using the customer's information stored in the database. In this way, the notification system of the present invention ensures that every winning customer is notified of their winning lottery ticket, thereby reducing unclaimed lottery winnings. Furthermore, the invention provides the functional benefit of digitizing the lottery ticket information into formatted data and linking the information with customer details such that, in case the customer wins the lottery, he/she may not need to retain the winning lottery ticket to claim the prize money.

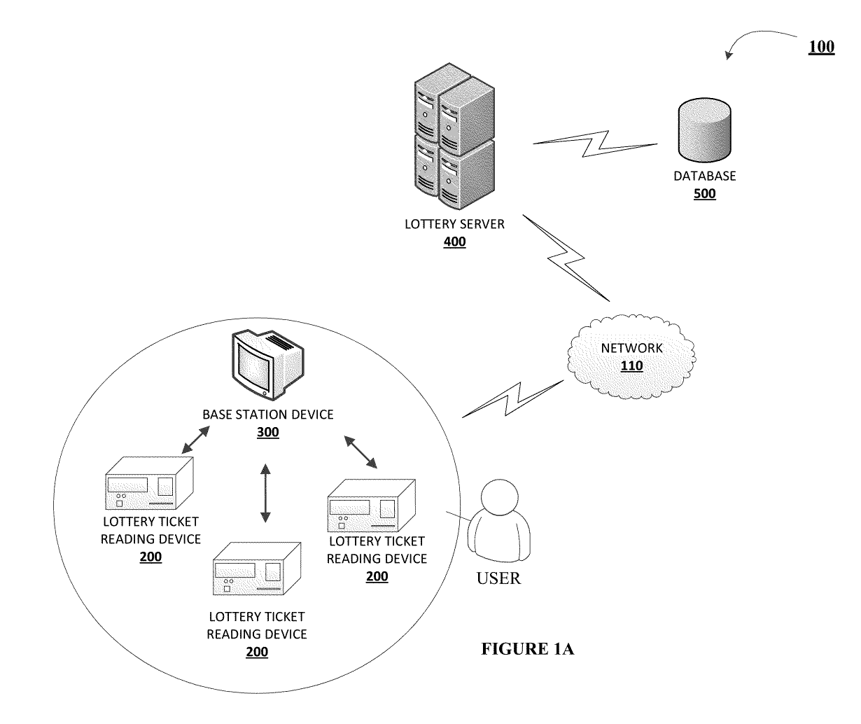

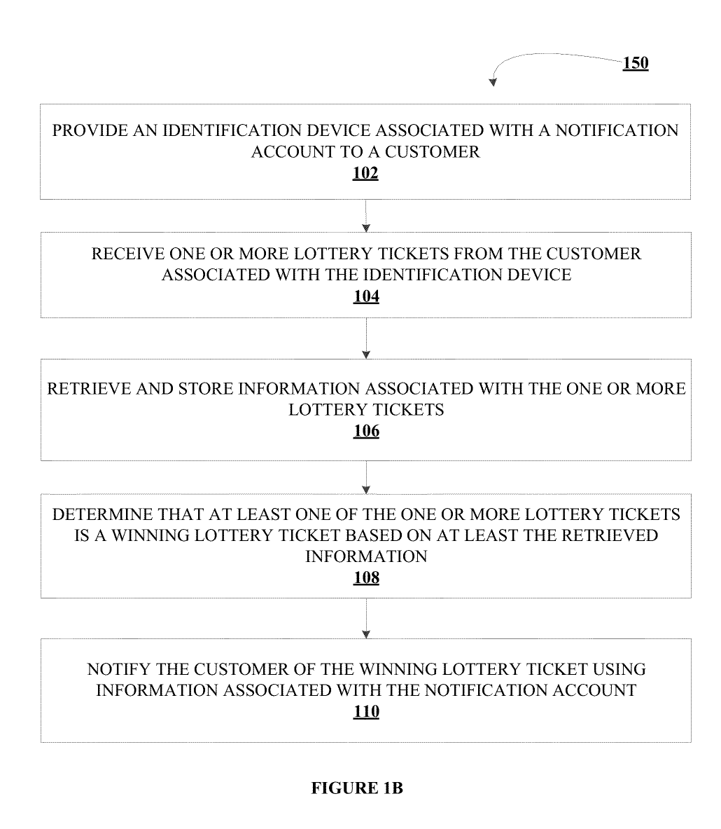

FIG. 1A illustrates a technology system environment for a lottery winnings notification system environment 100 in accordance with an embodiment of the present invention. In some cases, the system environment 100 may refer to the “apparatus” as described herein. As illustrated, the system environment 100 includes a network 110, a lottery ticket reading device 200, a base station device 300, a lottery server 400, and a database 500. The system environment 100 shown in FIG. 1A may be located at least partially at a facility associated with an entity (such as a merchant, retailer, store, etc.) or remotely from the facility associated with the entity.

As used herein, an “entity” may refer to any business dealing with the sale of goods and/or services from individuals or businesses to the end-user. For purposes of the invention, the term “entity” and “merchant” may be used interchangeably.

As shown in FIG. 1A, the lottery ticket reading device 200, the base station device 300, the lottery server 400, and the database 500 are each operatively and selectively connected to the network 110, which may include one or more separate networks. The network 110 may include one or more of a telecommunication network, local area network (LAN), a wide area network (WAN), Near Field Communication network (NFC), a global area network (GAN), such as the Internet, Radio-frequency identification (RFID) and/or other wireless communication networks operating in a predetermined physical area range, associated with mechanical/electromagnetic waves. The network 110 or portions of the network 110 may be secure and/or unsecure and may also include wireless and/or wired and/or optical interconnection technologies.

The embodiment of the system environment 100 illustrated in FIG. 1A is exemplary and other embodiments of the invention may differ. As another example embodiment, the system environment 100 may include more, less, or different components. As another example, in some embodiments, some or all of the portions of the system environment 100 may be combined into a single portion. Likewise, in some embodiments, some or all of the portions of the system environment 100 may be separated into two or more distinct portions. In this regard, the system environment 100 of the lottery winnings notification system may be located within a physical location of a merchant, or an entity responsible for maintaining the system. In addition, the various portions of the system environment 100 may be maintained for and/or by the same or separate entities.

In some embodiments, the lottery ticket reading device 200, the base station device 300, the lottery server 400, the database 500, and/or one or more components explained herein may be independent or stand-alone devices communicating via network 110. In another embodiments, the lottery ticket reading device 200, the base station device 300, the lottery server 400, the database 500, and/or one or more components explained herein may be one or more components of the same device.

FIG. 1B illustrates a high level process flow 150 for a lottery winnings notification system. One or more steps of the process flow 150 may be performed by the lottery ticket reading device 200, the base station device 300, the lottery server 400, the database 500, a customer identification device and/or one or more third-party devices, either singularly or in combination. As shown in block 102, the process flow includes providing an identification device, associated with a notification account, to a customer. In some embodiments, the identification device may include one or more loyalty devices, magnetic-based tags, key fobs, radio frequency identification device (RFID), mobile devices, smart phones, cellular phones, personal digital assistant (PDA) devices, and Moving Picture Experts Group Layer-3 Audio (MP3) devices, wearable devices, and personal global positioning system (GPS) devices. In one aspect, the identification device may be issued to the customer by the merchant. In another aspect, the identification device may be associated with one or more merchants. In yet another aspect, the process 150 may comprise modifying an existing device of the customer to provide the identification device. For example, the “system” comprising the lottery ticket reading device 200, the base station device 300 and/or the lottery server 400, may establish an operative communication channel with a suitable customer device (for example, a mobile device, PDA, wearable device and the like), via the network 110 based on receiving device identification information and/or authorization from the user. The system may then transmit and install a customer application configured for lottery winning notifications, thereby converting an existing customer device into an identification device.

In some embodiments, the identification device may include a customer preference device that stores customer preference data corresponding to one or more customer preferences regarding transaction sessions or other preferences. For example, in some embodiments, a customer preference device may include one or more of a memory device, a communication device such as an RFID or magnetic-based communication device such as a magnetic strip or the like. The customer preference device is configured for communicating the customer preference data to the lottery ticket reading device 200 at the point of sale as discussed further below, based on a contactless operation, physical swipe of device, chip card interface, wired operation or a suitable network. In this regard, the customer preference data may be encoded or encrypted prior to storing, such that only devices/applications comprising a customer specific decoding key may decipher the customer preference data. For example, the lottery ticket reading device 200 and/or the customer application may comprise the customer specific decoding key. In other embodiments, the identification device includes a customer preference device that stores pointer data indicating the location where customer preference data is stored and/or decoding key required to decipher the customer preference data.

In some embodiments, the identification device may be an active device. In this regard, the active identification device may include an on-board battery enabling the device to periodically store information and transmit the information stored therein. In another embodiment, the identification device may be a battery-assisted passive device. In one aspect, the battery-assisted passive device may include an on-board battery configured to be activated in the presence of the identification device reader. In yet another embodiment, the identification device may be a passive device. In this regard, the identification device may be capable of being activated by a signal transmitted from the identification device reader. In some instances, the lottery ticket reading device 200 may transmit a first type of encoded instructions via audio waves, ultrahigh frequency waves and the like, either intermittently or based on determining that the customer is in the vicinity. The first type of encoded instructions may be decoded by the customer application, running in the background. The customer application may then cause changes in the functioning of the identification device, based on the instructions, for example, turning the device on/off as required to conserve power, causing the display to present an interface associated with the customer application, causing the screen to lock the existing display until the customer performs a predetermined action, causing the device to vibrate, changing the brightness of the display to optimize power consumption, and the like. In some instances, if the customer application is closed/if the identification device is offline, the system may transmit first type of instructions comprising ultra-high frequency waves, text messages and the like, which are configured to cause the customer application to be activated/the device to connect to a suitable network.

In some embodiments, a notification account may be a loyalty account associated with a conventional merchant-customer relationship. Typically, a notification account may be linked to the customer identification device. In one aspect, the notification account may include customer information including, but not limited to information associated with a unique identifier for the customer, the customer's e-mail, mobile phone, address, social media, instant messenger, blogs, website, or the like.

In another aspect, the notification account may include location information associated with the customer. Embodiments of the invention may collect positioning data of the customer, which may include global positioning data. Global positioning data may include any information collected from methods, systems, apparatuses, computer programs etc. involving locating a user's position relative to satellites, fixed locations, beacons, transmitters or the like. In one aspect, the global positioning data may be collected from a location determining device associated with the customer's identification device. In some instances, global positioning data may be collected from a GPS device, such as a navigation system. Such a navigation system may be, but is not limited to, hardware and/or software that is part of a mobile phone, smartphone, PDA, automobile, watch etc. or a commercially available personal navigation system. The amount, nature and type of the global positioning data that is collected may depend on the amount of information that the customer has authorized the lottery winning notification system or third-party provider to collect.

In one aspect, the customer's identification device may include a store value card with a monetary value on the card itself and not linked to an external account maintained by a financial institution. In another aspect, the identification device may include a store value card linked to an external account maintained by a financial institution. The value associated with the card can be accessed using at least one of a magnetic stripe embedded in the card, on which the card number is encoded, a radio frequency identification (RFID), entering a code number associated with the identification device into a telephone or numeric keypad, or the like. In some embodiments, the store value card may be a closed system prepaid card. In this regard, the store value card may be issued by the merchant and may only be redeemed for purchases from the merchant. They are typically available in fixed amounts. In some other embodiments, the store value card may be a semi-closed system prepaid card. In this regard, the customer associated with the store value card is permitted to redeem the cards at multiple merchants within a geographic area. In one aspect, the store value card may be issued by the merchant. In another aspect, the store value card may be issued by a third party. In another aspect the store value card may refer to a digital wallet application of the identification device, comprising one or more payment credentials/tokens associated with one or more customer financial accounts, financial instruments, loyalty/rewards accounts and the like.

The process flow then receives one or more lottery tickets from the customer associated with the identification device, as shown in block 104. In response, the process flow includes retrieving and storing information associated with the one or more lottery tickets, as shown in block 106. In some embodiments, the system may be configured to capture one or more images of each of the one or more lottery tickets. In this regard, the lottery ticket reading device 200 may comprise an image capture device that is configured to capture the one or more images. The system may process the captured one or more images and extract or retrieve relevant information or metadata associated with the lottery ticket. In this regard, the system may be configured to implement character/pattern recognition techniques such as Optical Character Recognition (OCR), Intelligent Character Recognition (ICR), or Intelligent Word Recognition (IWR) to convert the images into machine-encoded text using one or more machine learning techniques. In this way, the received one or more lottery tickets may be digitized to be stored for future use. In one aspect, the information retrieved from the lottery ticket may include, but is not limited to, a game type, submission date, game date, options played, lottery drawing date, ticket type or the like. For example, a game type may include, but is not limited to multi-state games, lotto, scratch-off, quick picks, or the like. The transformation of visual data associated with the captured images to the electronic data associated with the digitalized, formatted data is described below.

Initially, the system may capture one or more images of each of the one or more lottery tickets. In this regard, the one or more images may comprise at least a portion of the front of the lottery tickets, at least a portion of the back of the lottery tickets, or any other portions of the lottery tickets. In cases where there are several lottery tickets piled into a stack, the multiple images may include, for example, at least a portion of each of the four sides of the stack. While, in some embodiments, the system may capture an image of the lottery ticket comprising the entirety of the front/back portion and then analyze the image for relevant data, in other embodiments the system may only capture and/or analyze images of portions of the lottery ticket that are most likely to contain the required data. The system may define portions of the lottery ticket, each portion having a specific spatial location identified using a suitable coordinate system, by separating elements of the ticket into quadrants/sectors/grids, based on the dimensions of the lottery ticket. The system may determine the portions of the lottery ticket that are most likely to contain the required data, based on retrieved lottery ticket templates, based on the type of lottery ticket determined by identifying a logo, a marking or a specific color in a predetermined portion of the ticket, based on identifying white spaces/spaces devoid of text, and/or based on employing heuristics. Here, the system may apply magnetic ink character recognition (MICR), optical character recognition (OCR) or another suitable process. Capturing and/analyzing only portions of the image that are likely to contain the required information provides a reduction in processing time and reduction in memory requirements.

Next, the system may conduct pre-processing of the captured images to correct misaligned data, enhance blurry data, determine unrecognizable data, and correct faded data and other data inconsistencies that are not recognized by the preliminary OCR process, and to increase the successful recognition of data by future OCR processes. Data “recognition”, as used herein, refers to the ability to identify characters, symbols and other printed information on the lottery ticket. In this regard, the system may correct the data inconsistencies based on learning from previously corrected data, based on receiving the correct data from the user, incorporating pattern matching techniques, based on evaluating the captured images on a pixel-by-pixel basis, ICR processes, image overlay processes and the like. Therefore, by performing preprocessing and transforming unrecognizable data to a form that would be recognizable by OCR processes, the present system is able to salvage lottery tickets and images that would otherwise be rejected.

The system may then apply OCR processes or other character recognition techniques to convert printed text, symbols and other corrected data in the lottery ticket images to formatted data comprising machine encoded text, such as text based files that can be edited and searched. The data in the lottery ticket images can also be extracted and converted into formatted data comprising metadata, which can then be used and incorporated into a variety of applications, documents, and processes.

Based on at least analyzing the formatted data and comparing the data with information associated with a winning ticket, the process flow may determine that at least one of the one or more lottery tickets is a winning lottery ticket, as shown in block 108. In some embodiments, the system may be configured to receive information associated with the winning lottery ticket from one or more external sources. In this regard, the system may receive a winning lottery number and determine that the winning lottery ticket numbers match the numbers from the lottery tickets received from the customer. In response, the system may be configured to notify the customer of the winning lottery ticket using customer information stored in the identification device.

In response to determining the winning lottery ticket, the process flow includes notifying the customer of the winning lottery ticket using the information associated with the notification account, as shown in block 110. In this regard, the system may be configured to receive information associated with a winning lottery ticket from one or more external sources and determine whether the information associated with the one or more lottery tickets received from the customer matches the winning lottery ticket. In one aspect, the system may transmit a notification to the customer as a text message, a pop-up notification, a vibratory alert, an email, automatic presentation of the customer application interface, an automatic snail mail, or the like. In another aspect, transmitting the notification may comprise causing changes to the functioning of the identification device, as described with respect to block 102.

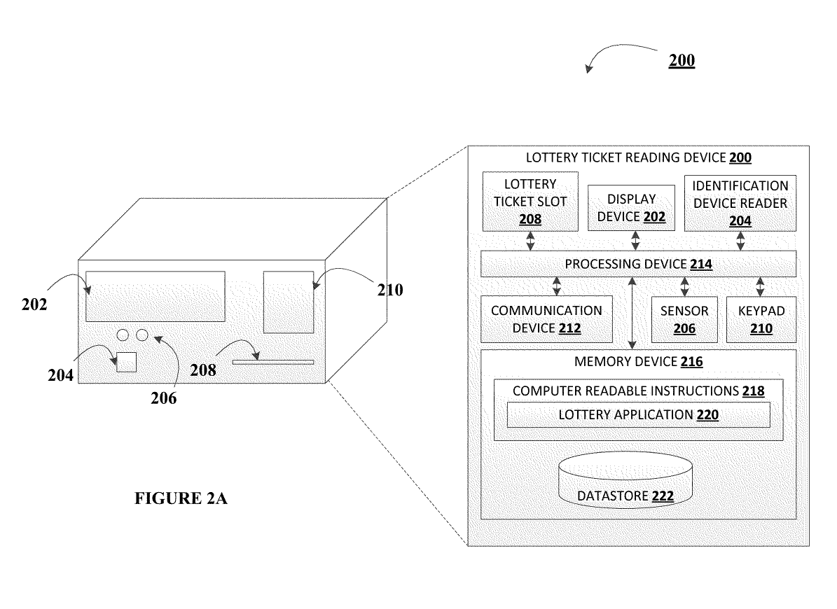

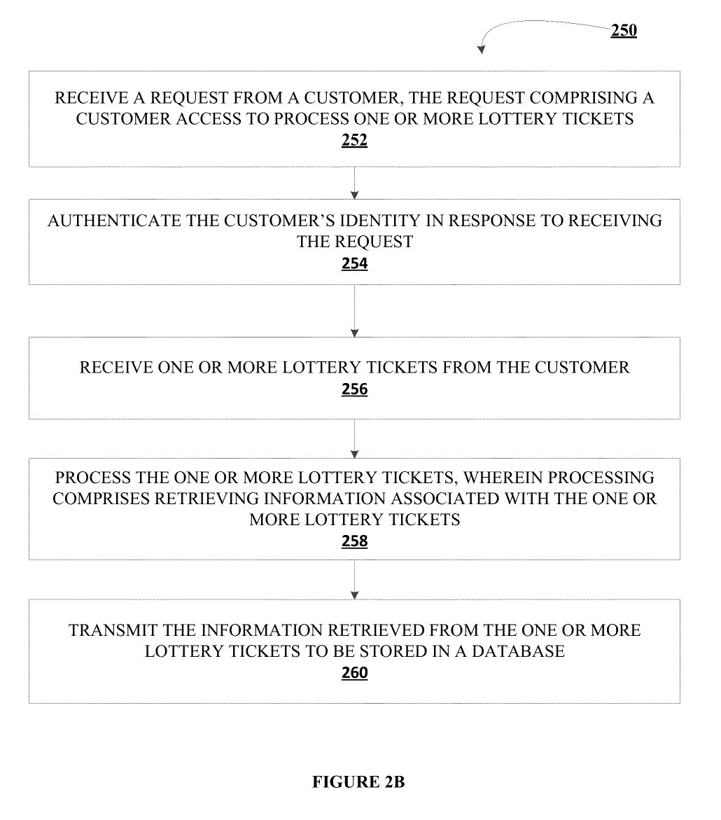

FIG. 2A illustrates an exemplary lottery ticket reading device 200 in accordance with an aspect of the invention 200. As shown in FIG. 2A, the lottery ticket reading device 200 has a display device 202, an identification device reader 204, a sensor 206, a lottery ticket receiving slot 208, a keypad 210, a communication device 212, a processing device, and a memory device 216. In some embodiments, the lottery ticket reading device 200 is a standalone device. In some embodiments, the lottery ticket reading device 200 is portable.

In some embodiments, the display device 202 is generally an output device for presentation of information in visual form. In this regard, the display device 202 may display customer input, at least a portion of the captured images, formatted data from the captured lottery ticket images, instructions for the customer, and other relevant data. In one aspect, the display device may be at least one of a Liquid Crystal Display (LCD), Light Emitting Diode (LED), segment displays, cathode ray tube (CRT), plasma, or the like. In some embodiments, the identification device reader 204 is generally classified based on the nature of the identification device. In this regard, the identification device reader may be a passive reader or an active reader. A passive identification device reader may be activated only based on receiving radio signals from an active identification device. An active identification device reader comprises an active reader which transmits interrogator signals and also receives authentication replies from active or passive identification devices. In yet another embodiment, the sensor 206 generally refers to a device that detects events or changes in quantities and provides a corresponding output, generally as an electrical or optical signal. For purposes of the invention, the sensor 206 may be configured to detect a customer's presence proximate to the lottery ticket reading device 200. In some embodiments, the lottery ticket reading device 200 may further comprise a transmitter or beacon device that transmits wireless instructions to the customer identification device based on a controller in communication with the sensor 206, a chip card interface device configured to read contactless/contact smart cards, a magnetic strip reader, a contactless payment terminal configured for receiving payment credentials/tokens, and other auxiliary devices.

As illustrated in FIG. 2A, the lottery ticket slot 208 generally refers to a lottery ticket acceptor capable of receiving the one or more lottery tickets from the customer and retrieve information associated with the lottery ticket to be stored in a database. In this regard, the lottery ticket slot 208 may comprise an image capture device configured to capture an image of each of the one or more lottery tickets received, as described previously. In some embodiments, the keypad 210 may refer to a numeric keyboard that allows a more efficient entry of numerical data, a keypad for the customer to provide authentication credentials, corrected data, and the like. In some embodiments, the lottery ticket reading device 200 may further comprise a fingerprint scanner, an iris scanner, a microphone configured for voice recognition and other devices, to enable the customer to provide biometric authentication credentials.

Processing device 214 is operatively coupled to the display device 202, the identification device reader 204, the sensor device 206, the lottery ticket slot 208, the keypad 210, and communication device 212 to communicate with the network and other devices on the network. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combination of the foregoing. Control and signal processing functions of the system are allocated between these processing devices according to their respective capabilities. The processing device may include functionality to operate one or more software programs based on computer readable instructions thereof, which may be stored in a memory device. The communication device 212 generally comprises a modem, server, or other device for communicating with other devices on the network.

As further illustrated in FIG. 2A, the lottery ticket reading device 200 comprises computer readable instructions 218 stored in the memory device 216, which in one embodiment includes the computer-readable instructions 218 of a lottery application 220. In the embodiments illustrated in FIG. 2A, the lottery application 220 enables the lottery ticket reading device 200 to be linked to the base station device to communicate via a network. The lottery application 220 may also allow the lottery ticket reading device 200 to connect directly (i.e. locally or device to device) with the base station device 300 for sending and receiving information. In one aspect, the lottery application 220 may allow the lottery ticket reading device 200 to connect directly (i.e. locally or device to device) with the lottery server 400 for sending and receiving information. In another aspect, the lottery ticket reading device 200 may establish wireless communication links with the identification device, for example, using near field communication. The lottery application 220 may perform one or more of the steps and/or sub-steps discussed herein and/or one or more steps not discussed herein.

In some embodiments, the lottery application 220 includes computer-executable program code portions for instructing the processing device 214 to perform any one or more of the functions of the lottery application 220 described and/or contemplated herein. In some embodiments, the lottery application 220 may include and/or use one or more network and/or system communication protocols.

In addition to the lottery application 220, the memory 216 also includes the datastore 222. As used herein, the datastore 222 may be one or more distinct and/or remote datastores. In some embodiments, the datastore 222 is not located within the lottery ticket reading device 200 and is instead located remotely from the lottery ticket reading device 200. In some embodiments, the datastore 222 stores information or data described herein.

In some embodiments, the datastore 222 may include any one or more storage devices, including, but not limited to, datastores, databases, repositories, and/or any of the other storage devices typically associated with a computer system. In some embodiments, the datastore 222 may store information in any known way, such as, for example, by using one or more computer codes and/or languages, alphanumeric character strings, data sets, figures, tables, charts, links, documents, and/or the like. Further, in some embodiments, the datastore 222 may include information associated with one or more applications, such as, for example, lottery application 220, information associated with a customer or a customer's financial account or another type of account, a transaction or payment, or the like. It will also be understood that, in some embodiments, the datastore 222 provides a substantially real-time representation of the information stored therein, so that, for example, when the processing device 214 accesses the datastore 222, the information stored therein is current or substantially current.

FIG. 2B illustrates a process flow 250 for retrieving information from one or more lottery tickets. As shown in block 252, the process flow includes receiving a request from a customer. The request, in some cases, includes a customer access to process one or more lottery tickets. In this regard, the customer may present the identification device to be detected by the lottery ticket reading device 200 at the identification device reader 204.

In response to detecting the identification device reader 204 proximate to lottery ticket reading device 200, the process flow includes authenticating the customer's identity, as shown in block 254. In some embodiments, the identification device associated with the customer may include one or more authentication credentials associated with the customer. In this regard, the system may be configured to verify the one or more authentication credentials received from the identification device, for example via a suitable wireless communication link. In one aspect, the system may be configured to compare the one or more received authentication credentials with one or more predetermined authentication credentials stored to determine a match. In some embodiments, the authentication credentials may include, but is not limited to a password, a personal identification number (PIN), biometrics, a challenge question, out of wallet questions, a telephone number or the like. In some embodiments, the authentication requirements may be twofold. For example, the customer may be required to input a pin on the keypad 210 that was transmitted to another customer device via email/text, or provide biometric authentication credentials via the identification device/the lottery ticket reading device 200, in addition to the credentials received from the identification device.

In some embodiments, the system may be configured to receive a request from the customer to process one or more lottery tickets based of the customer's presentation of the identification device. In response, the system may then present on the display device 202 of the lottery ticket reading device 200, a challenge question. In one aspect, the system may be configured to set up a challenge question and a verification answer when the customer is initially issued the identification device. The customer may be required to enter the verification answer in response to the challenge question to access the lottery ticket reading device and process the lottery tickets. The system may then authenticate the customer based on a successful verification of the customer's verification answer.

In some embodiments, in response to authenticating the customer, the system may then be configured to receive one or more lottery tickets from the customer. In this regard, the sensor 206 associated with the lottery ticket device 200 may detect the presence of the customer in proximity to the lottery ticket device 200 and initiate the lottery ticket device 200 to receive the one or more lottery tickets. In one aspect, the system may be configured to receive the one or more lottery tickets individually. In another aspect, the system may be configured to receive the one or more lottery tickets simultaneously. In yet another aspect, the system may be configured to receive the one or more lottery tickets consecutively.

Typically, each of the one or more lottery tickets includes an associated monetary value for purchase. In one aspect, the customer may purchase the lottery ticket at a merchant location prior to submitting the lottery ticket for processing at the lottery ticket reading device 200. In this regard, the customer may purchase the one or more lottery tickets at a point of sale (POS) location of the merchant location. In another aspect, in response to authenticating the customer, the system may debit a monetary value associated with each of the one or more lottery ticket presented at the lottery ticket reading device 200 by the customer. In this regard, the system may be configured to present a remaining balance in the customer's identification device on the display device 202 of the lottery ticket reading device 200. In one aspect, the system may be configured to present a total monetary value debited from the customer's identification device for the one or more tickets received from the customer on the display device 202 of the lottery ticket reading device 200. In some embodiments, the system may debit a monetary value associated with a financial account of the customer, based on transmitting control instructions that cause the digital wallet application of the identification device to transmit one or more payment credentials or tokens to the lottery ticket reading device 200, via a contactless payment channel using radio-frequency identification (RFID) or near field communication (NFC) for secure payment.

In one aspect, if the remaining balance in the customer's identification device is less than the monetary value of the lottery ticket, the customer may be denied the lottery ticket. In another aspect, if the remaining balance in the customer's identification device is less than the monetary value of the lottery ticket, the system may temporarily pause the processing of the lottery ticket. In response, the system may be configured to initiate the presentation of one or more payment options to the customer to enable the customer load additional funds, or choose alternate financial instruments/tokens to continue processing the one or more lottery tickets. In one aspect, the one or more payment options may include, but are not limited to, loading additional funds on the store value card of the identification device, loading the requisite funds directly to complete only the current transaction, presenting additional funds to the merchant associated with the system, or the like. In response to receiving the additional funds, the system may continue processing the one or more lottery tickets based on at least determining that the remaining balance in the customer's notification account additional funds loaded by the customer is greater than or equal to the monetary value associated with the one or more lottery tickets received from the customer.

In response to receiving the one or more lottery tickets from the customer, the process flow includes processing the one or more lottery tickets, wherein processing comprises retrieving information associated with the one or more lottery tickets, as shown in block 258. In this regard, the system may be configured to capture a visual of each of the one or more lottery tickets when presented to the lottery ticket reading device 200 through the lottery ticket slot 208. In some embodiments, the system may be configured to extract one or more geometric features associated with each of the one or more lottery tickets. In this regard, the system may be configured to perform edge detection to identify points at which the image brightness changes sharply, or more formally, has discontinuities. In one aspect, edge detection may be implemented using Hough Transform. Typically, Hough Transformation is a feature extraction technique used in image analysis, computer vision, and digital image processing to find imperfect instances of objects within a certain class of shapes by a voting procedure. In some embodiments, the edge detection may be performed on the captured image of the lottery ticket. In another embodiment, the edge detection may be performed on the lottery ticket in real-time, when the lottery ticket is received by the lottery ticket reading device 200 through the lottery ticket slot 208. These processing operations may be similar to those described previously with respect to block 106.

In some embodiments, the system may be configured to display on the display device 202, a status for each of the one or more lottery tickets received from the customer. In this regard, the system may determine whether the one or more lottery tickets received from the customer have been successfully received and processed. In one aspect, the system may display on the display device 202, a number of lottery tickets processed, a total monetary value debited from the customer's store value card in the identification device, a completion message, or the like. In response, the system may be configured to receive an input from the customer confirming that the status is accurate. In case of an inaccurate status, the system may reset and enable the customer to repeat the process.

In response to processing the one or more lottery tickets, the process flow includes transmitting the information retrieved from the one or more lottery tickets to be stored in a database, as shown in block 260. In this regard, the system may use one or more image compression techniques to reduce irrelevance and redundancy of the image data to be able to store and transmit the image in an efficient form.

In some embodiments, the system may be configured to reset the lottery ticket reading device 200 based on at least detecting the presence of the customer in proximity to the lottery ticket reading device 200, to ensure data security and for efficient power utilization. For example, the lottery ticket reading device 200 may reset and await the next customer if the previous customer is not detected in the proximity of the lottery ticket reading device 200.

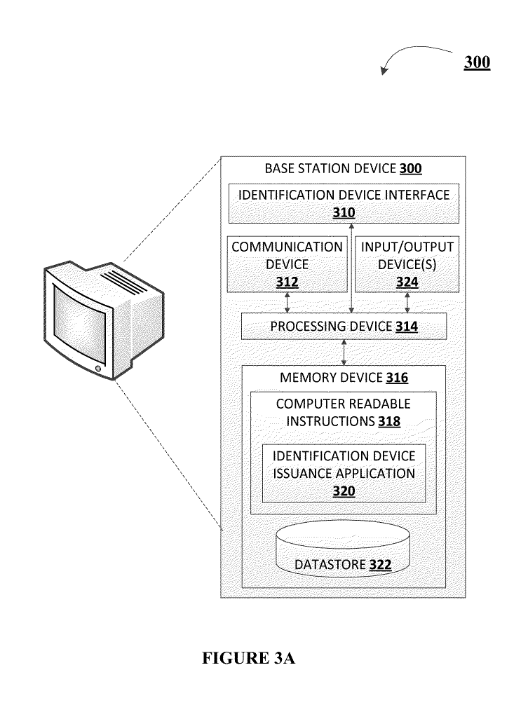

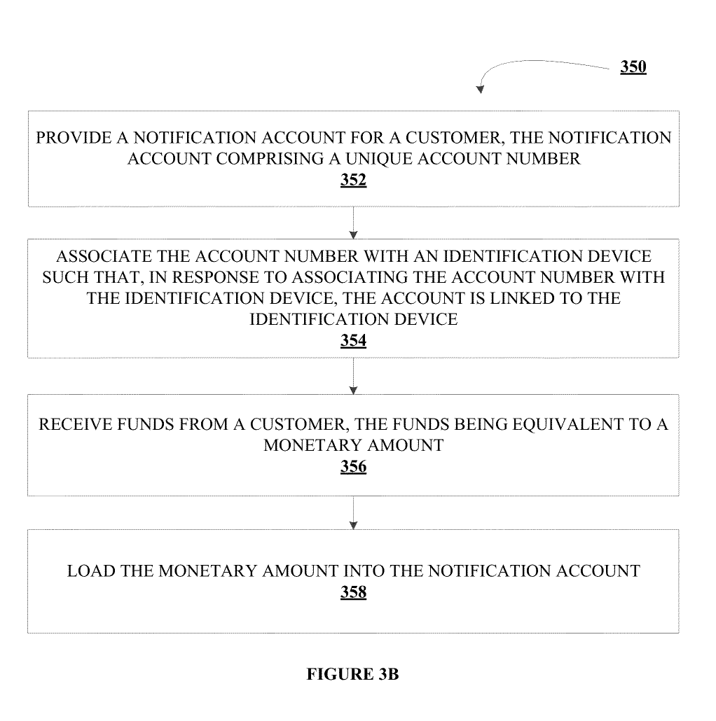

FIG. 3A illustrates an exemplary base station device 300 in accordance with an embodiment of the invention 300. As shown in FIG. 3A, the base station device 300 includes an identification device interface 310, a communication device 312, an input/output device 324, a processing device 314, and a memory device 316. The processing device 314 is operatively coupled to the identification device interface 310, the input/output device(s) 324, and the communication device 312 to communicate with the network and other devices on the network. For example, the communication device 312 may be configured to enable the base station device 300 to transmit and receive instructions from one or more lottery ticket reading devices 200. In another example, the communication device 312 may be configured to enable the base station to transmit and receive instructions from the lottery server 400. As such, the communication device 312 generally comprises a modem, server, or other device for communicating with other devices on the network.

In some embodiments, the identification device interface 310 may be configured to receive customer input for the generation of an identification device. In this regard, the customer may enter one or more information fields such as name, age, phone number, address, or the like using the identification device interface 310. In response, the system may be configured to provide the customer with an identification device comprising a unique identification number.

As further illustrated in FIG. 3A, the base station device 300 comprises computer readable instructions 318 stored in the memory device 316, which in one embodiment includes the computer-readable instructions 318 of an identification device issuance application 320. In the embodiments illustrated in FIG. 3A, the identification device issuance application 320 enables the base station device 300 to be linked to the lottery server 400 to communicate via a network 110. The identification device issuance application 320 may also enable the base station device 300 to connect directly (i.e. locally or device to device) with the lottery server 400 for sending and receiving information. The identification device issuance application 320 may perform one or more of the steps and/or sub-steps discussed herein and/or one or more steps not discussed herein. For example, in some embodiments, the identification device issuance application 320 may issue an identification device to the customer.

In some embodiments, the identification device issuance application 320 includes computer-executable program code portions for instructing the processing device 314 to perform any one or more of the functions of the identification device issuance application 320 described and/or contemplated herein. In some embodiments, the identification device issuance application 320 may include and/or use one or more network and/or system communication protocols.

In addition to the identification device issuance application 320, the memory 316 also includes the datastore 322. As used herein, the datastore 322 may be one or more distinct and/or remote datastores. In some embodiments, the datastore 322 is not located within the base station device 300 and is instead located remotely from the base station device 300. In some embodiments, the datastore 322 stores information or data described herein.

In some embodiments, the datastore 322 may include any one or more storage devices, including, but not limited to, datastores, databases, repositories, and/or any of the other storage devices typically associated with a computer system. It will also be understood that the datastore 322 may store information in any known way, such as, for example, by using one or more computer codes and/or languages, alphanumeric character strings, data sets, figures, tables, charts, links, documents, and/or the like. Further, in some embodiments, the datastore 322 may include information associated with one or more applications, such as, for example, identification device issuance application 320, information associated with a customer or a customer's financial account or another type of account, a transaction or payment, or the like. It will also be understood that, in some embodiments, the datastore 322 provides a dynamic and substantially real-time representation of the information stored therein, so that, for example, when the processing device 314 accesses the datastore 322, the information stored therein is current or substantially current.

FIG. 3B illustrates a high level process flow 350 for issuing an identification device to a customer. As shown in block 352, the process flow includes providing a notification account for a customer, the notification account comprising a unique account number. In some embodiments the notification account stores password-protected information about a customer's identity, purchase history, and current purchase status. This information is typically saved between visits, and retrieved when the customer accesses the lottery ticket reading device 200. Typically, each notification account includes a unique account number.

In some embodiments, the information associated with the notification account, customer identity, funds, or the like may be stored directly on the identification device associated with the customer. In this regard, when the customer presents the identification device at a lottery ticket reading device 200, the system may retrieve information stored on the identification device to begin processing the one or more lottery tickets. In another embodiment, the information associated with the notification account, customer identity, funds, or the like may be stored in a back-end database associated with the customer. In one aspect, the customer's identification device may include a pointer (e.g., a unique identification number, account number, or the like) to the back-end database associated with the customer. In this regard, when the customer presents the identification device at a lottery ticket reading device 200, the system may receive the pointer from the customer's identification device and retrieve the corresponding information stored in the back-end database to being processing the one or more lottery tickets.

In response, the process flow includes associating the account number with an identification device such that, in response to associating the account number with the identification device, the account is linked to the identification device, as shown in block 354. In one aspect, the account is linked to the store value card in the identification device associated with the customer. In this regard, the process flow includes receiving funds from a customer, the funds being equivalent to a monetary amount, as shown in block 356.

In response to receiving funds from the customer, the process flow includes loading the monetary amount into the notification account of the customer, as shown in block 358. In some embodiments, the system may configure the base station device 300 to receive funds from the customer and load the customer's identification device with an equivalent monetary amount. In this regard, the base station device 300 may receive one or more authentication credentials from the customer to verify the customer's identity prior to loading the monetary amount into the notification account of the customer, similar to those described previously. In another embodiment, the customer may present funds to the merchant associated with the lottery winnings notification system, who in-turn, may load the customer's identification device with an equivalent monetary amount. In one aspect, the base station device may include a financial institution card reader (not shown in the figures) to receive funds from the customer to be loaded on the store value card in the identification device. In this regard, the customer may swipe a financial institution bank card using the card reader and determine an amount of funds to be loaded into the store value card. In one aspect, the system may be configured to enable the base station device 300 to allow for registration of new customers. In another aspect, system may be configured to enable the base station device 300 to allow for recharging the store value card in an existing customer's identification device.

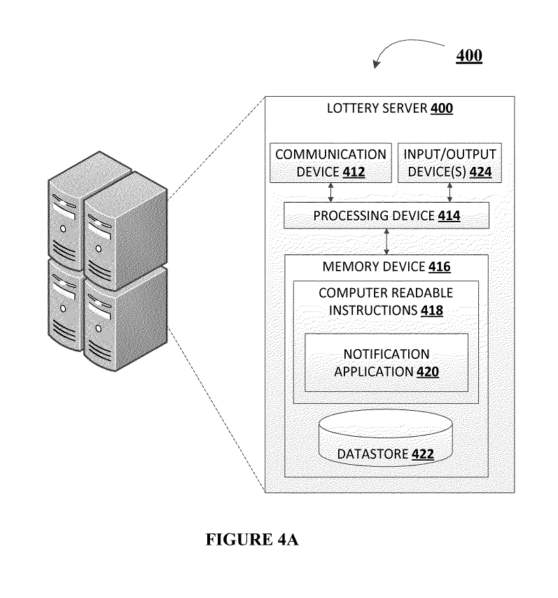

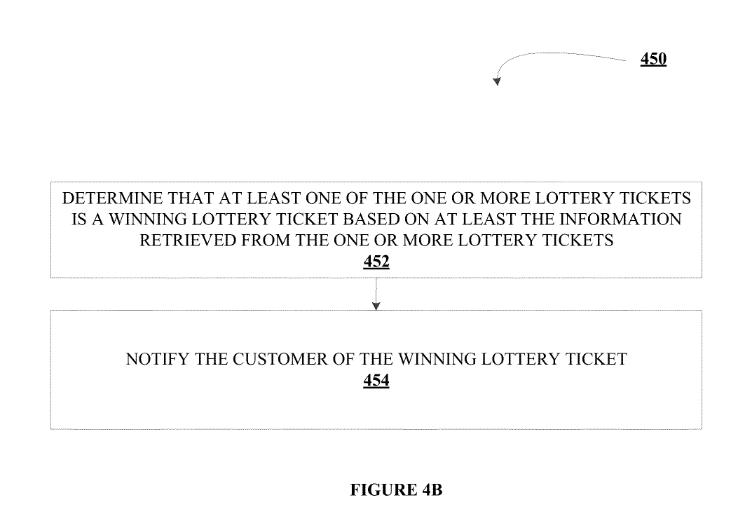

FIG. 4A illustrates an exemplary lottery server in accordance with an embodiment of the invention 400. As shown in FIG. 4A, the lottery server 400 comprises a communication device 412, an input/output device 424, a processing device 414, and a memory device 416. The processing device 414 is operatively coupled to the communication device 412 to communicate with the network and other devices on the network. For example, the communication device 412 may be configured to enable the lottery server 400 to transmit and receive instructions from one or more base station devices 300. In another example, the communication device 412 may be configured to enable the lottery server 400 to transmit and receive instructions from the database 500. As such, the communication device 412 generally comprises a modem, server, or other device for communicating with other devices on the network.

As further illustrated in FIG. 4A, the lottery server 400 comprises computer readable instructions 418 stored in the memory device 416, which in one embodiment includes the computer-readable instructions 418 of a notification application 420. In the embodiments illustrated in FIG. 4A, the notification application 420 allows the lottery server 400 to be linked to the base station device 300 to communicate via a network 110. The notification application 420 may also allow the lottery server 400 to connect directly (i.e. locally or device to device) with the database 500 for sending and receiving information associated with the one or more lottery tickets and each customer. The notification application 420 may perform one or more of the steps and/or sub-steps discussed herein and/or one or more steps not discussed herein. For example, in some embodiments, the notification application 420 may notify the customer of a winning lottery ticket based on at least determining that the one or more lottery tickets received from the customer is a winning lottery ticket.

It will be further understood that, in some embodiments, the notification application 420 includes computer-executable program code portions for instructing the processing device 414 to perform any one or more of the functions of the notification application 420 described and/or contemplated herein. In some embodiments, the notification application 420 may include and/or use one or more network and/or system communication protocols.

In addition to the notification application 420, the memory 416 also includes the datastore 422. As used herein, the datastore 422 may be one or more distinct and/or remote datastores. In some embodiments, the datastore 422 is not located within the base station device 300 and is instead located remotely from the lottery server 400. In some embodiments, the datastore 422 stores information or data described herein.

It will be understood that the datastore 422 may include any one or more storage devices, including, but not limited to, datastores, databases, repositories, and/or any of the other storage devices typically associated with a computer system. It will also be understood that the datastore 422 may store information in any known way, such as, for example, by using one or more computer codes and/or languages, alphanumeric character strings, data sets, figures, tables, charts, links, documents, and/or the like. Further, in some embodiments, the datastore 422 may include information associated with one or more applications, such as, for example, notification application 420, information associated with a customer or a customer's financial account or another type of account, a transaction or payment, or the like. It will also be understood that, in some embodiments, the datastore 422 provides a substantially real-time representation of the information stored therein, so that, for example, when the processing device 414 accesses the datastore 422, the information stored therein is current or substantially current.

FIG. 4B illustrates a high level process flow 450 for notifying a customer of the winning lottery ticket in accordance with an embodiment of the invention. As shown in block 452, the process flow includes determining that at least one of the one or more lottery tickets is a winning lottery ticket based on at least the information retrieved from the one or more lottery tickets received from the customer. As discussed earlier, in some embodiments, the lottery server 400 receives information associated with the one or more lottery tickets received from the customer. In response, the lottery server 400 associates the customer's information with the information associated with the one or more lottery tickets and transmits the information to the database 500 to be stored. In this regard, the lottery server 400 may receive information associated with a winning lottery ticket from one or more external sources and determine whether the information associated with the one or more lottery tickets received from the customer matches the winning lottery ticket. In one aspect, the one or more external sources may include, but not limited to, independent third party businesses associated with the lottery game, an entity registered with the government and authorized to determine lottery winners, a winning numbers announced by a state lottery on the Internet, public radio, or the like. In some embodiments, the system may be configured to continuously monitor the database 500 to determine whether the information associated with a winning lottery from the one or more external sources matches the information associated with the one or more lottery tickets received from the customer. In one aspect, the database 500 may store the information associated with the one or more lottery tickets received from the customer until the lottery ticket winner has been announced. In this regard, the system may be configured to purge the one or more lottery tickets from the database 500 if the information associated with the one or more lottery tickets from the customer is not the winning lottery ticket.

In response, the process flow includes transmitting a notification to the customer of the winning lottery ticket, as shown in block 454. In this regard, the system may notify the customer based on at least the customer information received and stored in the database 500 when the customer initially presented the lottery ticket to the lottery ticket reading device 200 to be processed. In one aspect, the notification may include, but is not limited to a short message service (SMS) on the customer's cell phone, a voice call relaying a recorded message on the customer's cell phone, an email, a physical mail, or the like. In another aspect, transmitting the notification may comprise causing changes to the functioning of the identification device, as described with respect to block 102.

Any of the features described herein with respect to a particular process flow may be also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for notifying a customer of a winning lottery ticket, the system comprising:
at least one non-transitory storage device;
at least one computing processor; and
at least one module stored in said storage device and comprising instruction code executable by the at least one computing processor, and configured to cause the at least one computing processor to:
receive one or more lottery tickets from the customer;
retrieve and store information associated with the one or more received lottery tickets;
determine that at least one of the one or more received lottery tickets is a winning lottery ticket based on at least the retrieved information; and
notify the customer of the winning lottery ticket.

2. A system for notifying a customer of a winning lottery ticket, the system comprising:
at least one lottery ticket reading device, the device comprising:
at least one non-transitory storage device;
at least one computing processor; and
at least one reading module stored in the storage device and comprising instruction code executable by the at least one computing processor, and configured to cause the at least one computing processor to:
receive one or more lottery tickets from the customer;
retrieve information associated with the one or more received lottery tickets; and
store the retrieved information in a database associated with the customer; and
at least one notification device operably connected to the at least one lottery ticket reading device, the device comprising:
at least one non-transitory storage device;
at least one computing processor; and
at least one notification module stored in the storage device and comprising instruction code executable by the at least one computing processor, and configured to cause the at least one computing processor to:
determine that at least one of the one or more received lottery tickets is a winning lottery ticket based on at least the retrieved information; and
notify the customer of the winning lottery ticket.

3. The system of claim 2, wherein the instruction code of the at least one notification module is further configured for causing the at least one processor to:
receive information associated with a winning lottery ticket from one or more external sources;
compare the information associated with the winning lottery ticket with the information associated with the one or more lottery tickets received from the customer to determine a match;
determine that at least one of the one or more lottery tickets received from the customer is the winning lottery ticket;
retrieve customer information from the database, wherein the customer information comprises a mobile phone number; and
transmit a notification to the customer indicating that the customer has purchased a winning lottery ticket.

4. The system of claim 3, wherein the instruction code of the at least one notification module is further configured for causing the at least one processor to transmit a notification to the user by at least one of a text message, multimedia message, social network message, email, or telephone call to the customer based on at least the customer information.

5. A system for receiving one or more lottery tickets from a customer, the system comprising:
at least one lottery ticket reading device, the device comprising:
at least one non-transitory storage device;
at least one computing processor; and
at least one lottery ticket reading module stored in the storage device and
comprising instruction code executable by the at least one computing processor, and
configured to cause the at least one computing processor to:
receive one or more lottery tickets from the customer;
retrieve information associated with the one or more lottery tickets; and
transmit the information associated with the one or more lottery tickets to a base station device; and
at least one base station device operably connected to the at least one lottery ticket reading device, the device comprising:
at least one non-transitory storage device;
at least one computing processor; and
at least one base station module stored in said storage device and comprising instruction code executable by the at least one computing processor, and configured to cause the at least one computing processor to:
receive information associated with one or more lottery tickets from the at least one lottery ticket reading module; and
transmit the information associated with the one or more lottery tickets received from the at least one lottery ticket module to be stored in a database.

6. The system of claim 5, wherein the instruction code of the at least one base station module is further configured for causing the at least one processor to:
provide a notification account for a customer, the notification account comprising an unique account number;
associate the account number with an identification device such that, in response to associating the account number with the identification device, the account is linked to the identification device;
receive funds from a customer, the funds being equivalent to a monetary amount; and
load the monetary amount into the notification account.

7. The system of claim 6, wherein the instruction code of the at least one base station module is further configured for causing the at least one processor to:
determine that the customer's notification account balance is lesser than a monetary value associated with the one or more lottery tickets received from the customer;
notify, using a display of the at least one lottery ticket reading device, that the customer does not have sufficient balance to process the one or more lottery tickets, wherein notifying further comprises temporarily pausing the processing of the one or more received lottery tickets;
initiate the presentation of one or more payment options to the customer to enable the customer load additional funds to continue processing the one or more lottery tickets;
receive a customer input to load additional funds using the one or more payment options; and
in response to loading the additional funds, continue processing the one or more lottery tickets based on at least determining that the remaining balance in the customer's notification account after the additional funds are loaded by the customer is greater than or equal to the monetary value associated with the one or more lottery tickets received from the customer.

8. The system of claim 5, wherein the instruction code of the at least one base station module is further configured for causing the at least one processor to:
initiate presentation of an identification device interface to a customer, wherein the identification device interface comprises one or more text fields to receive customer information;
receive a customer input, the customer input comprising information associated with the customer; and
provide a notification account for the customer based on at least the received customer information.

9. The system of claim 5, wherein the instruction code of the lottery ticket reading module is further configured for causing the at least one processor to:
receive a request from the customer to access the lottery ticket reading module, the request comprises receiving an identification device associated with the customer;
retrieve one or more authentication credentials associated with the customer from the identification device;
validate the one or more authentication credentials; and
authenticate the customer's identity based on at least validating the one or more authentication credentials.

10. The system of claim 5, wherein the instruction code of the lottery ticket reading module is further configured for causing the at least one processor to:
capture and image of the one or more lottery tickets received from the customer; and
retrieve information associated with the one or more lottery tickets from the captured image by using optical character recognition (OCR), wherein the information comprises at least a lottery game type, submission date, lottery game date, lottery options played by the customer, lottery drawing date, and a lottery ticket type.

11. The system of claim 5, wherein the instruction code of the lottery ticket reading module is further configured for causing the at least one processor to:
present, in response to authenticating the customer's identity, an account balance associated with a customer's notification account on a display of the at least one lottery ticket reading device;
receive the one or more lottery tickets from the customer;
debit from the customer's account balance, a monetary value associated with each of the one or more lottery tickets; and
present, in response to debiting, an updated account balance on the display.

12. The system of claim 5, wherein the instruction code of the lottery ticket reading module is further configured for causing the at least one processor to:
determine, using a sensor device, that the customer is located in proximity to the module prior to receiving an identification device from the customer for authentication.

13. The system of claim 5, wherein the instruction code of the lottery ticket reading module is further configured for causing the at least one processor to:
present, on a display of the at least one lottery ticket reading device, instructions for receiving the one or more lottery tickets after authenticating the customer's identity.

14. The system of claim 5, wherein the instruction code of the lottery ticket reading module is further configured for causing the at least one processor to:
present, on a display of the at least one lottery ticket reading device, a message indicating the one or more lottery tickets were successfully received and/or processed.

15. The system of claim 5, wherein the instruction code of the lottery ticket reading module is further configured for causing the at least one processor to:
present, on a display of the at least one lottery ticket reading device, an advertisement provided by at least one of a merchant where the system is located or an entity responsible for maintaining the system.

16. A computer implemented method for notifying a customer of a winning lottery ticket, the method comprising:
receiving, using a computing device processor, one or more lottery tickets from the customer at one or more lottery ticket reading devices;
retrieving, using a computing device processor, information associated with the one or more lottery tickets from each of the one or more lottery ticket reading devices;
determining, using a computing device processor, that at least one of the one or more received lottery tickets is a winning lottery ticket based on at least the retrieved information; and
notifying, using a computing device processor, the customer of the winning lottery ticket.

17. The computer implemented method of claim 16, the method further comprising:
transmitting, using a computing device processor, the information associated with the one or more lottery tickets from each of the one or more lottery ticket reading devices to a base station device; and
transmitting, using a computing device processor associated with the base station device, the information associated with the one or more lottery tickets received from the one or more lottery ticket reading devices to a database for storage.

18. The computer implemented method of claim 16, the method further comprising:
receiving, using a computing device processor, information associated with a winning lottery ticket from one or more external sources;
comparing, using a computing device processor, the information associated with the winning lottery ticket with the information associated with the one or more lottery tickets received from the customer to determine a match;
determining, using a computing device processor, that at least one of the one or more lottery tickets received from the customer is the winning lottery ticket;
retrieving, using a computing device processor, customer information from a database, wherein the customer information comprises a mobile phone number; and
transmitting, using a computing device processor, a notification to the customer indicating that the customer has purchased a winning lottery ticket.

19. A computer program product for notifying a customer of a winning lottery ticket, the computer program product comprising a non-transitory computer-readable medium comprising code causing a first apparatus to:
receive one or more lottery tickets from the customer at one or more lottery ticket reading devices;
retrieve information associated with the one or more lottery tickets from each of the one or more lottery ticket reading devices;
determine that at least one of the one or more received lottery tickets is a winning lottery ticket based on at least the retrieved information; and
notify the customer of the winning lottery ticket.

20. The computer program product of claim 19, wherein the non-transitory computer-readable medium further comprises code configured to cause the first apparatus to:
transmit the information associated with the one or more lottery tickets from each of the one or more lottery ticket reading devices to a base station device;
receive information associated with a winning lottery ticket from one or more external sources;
compare the information associated with the winning lottery ticket with the information associated with the one or more lottery tickets received from the customer to determine a match;
determine that at least one of the one or more lottery tickets received from the customer is the winning lottery ticket;
retrieve customer information from the database, wherein the customer information comprises a mobile phone number; and
transmit a notification to the customer indicating that the customer has purchased a winning lottery ticket.
